(19) United States
(12) Patent Application Publication
(10) Pub. No.: US 2016/0068291 A1
(43) Pub. Date: Mar. 10, 2016

(54) PACKING MACHINE WITH A POROUS AGENT

(71) Applicant: GEA FOOD SOLUTIONS GERMANY GMBH, Biedenkopf-Wallau (DE)

(72) Inventor: Reiner PAUL, Steffenberg (DE)

(21) Appl. No.: 14/785,996

(22) PCT Filed: Apr. 17, 2014
(86) PCT No.: PCT/EP2014/057877

§ 371 Date: Oct. 21, 2015

(30) Foreign Application Priority Data
Apr. 23, 2013 (DE) 10 2013 207 365.8

(51) Int. Cl. B65B 47/02; F27B 9/28; B65B 61/06; F27B 9/04; B65B 9/04; B65B 47/06

(52) U.S. Cl. CPC B65B 47/02; B65B 9/045; B65B 47/06; B65B 61/06; F27B 9/04; F27B 9/28

(57) ABSTRACT

The present invention relates to a packing machine having:—a heating device, which heats up a film web—a forming station by means of which packing blisters are formed in the film web and/or the top film web, preferably by deep drawing;—a filling station in which the packing blisters are filled with a material to be packed;—a sealing station which seals a top film web to the packing blister; and—a longitudinal and/or transverse cutter, which separates the finished packages. The present invention also relates to a method for heating up a film web using a heating device which comprises a heated porous agent.

The present invention relates to a packaging machine having:
a heating device, which heats a film web,
a molding station by means of which packaging depressions are molded in the film web and/or the upper film web, preferably by deep drawing,
a filling station in which the packaging depressions are filled with a material to be packaged,
a sealing station which seals an upper film web to the packaging depression, and
a longitudinal and/or transverse cutter, which separates the finished packages.

Furthermore, the present invention relates to a method for heating a film web using a heating device which has a heated, porous agent.

Packaging machines and methods of this type are known from the prior art and are used, for example, in order to pack sliced foodstuffs, for example slices of sausage, cheese and/or ham or other products that can be weighed and/or counted. These packaging machines are designated as so-called forming-filling-sealing packaging machines (FFS packaging machines), tray formers, or tray sealers. In these packaging machines, a lower film web is transported cyclically along the packaging machine and firstly one or more packaging depression(s) per format are molded into the previously heated lower film web by using a plunger and/or negative pressure. Each packaging depression is then filled in a filling station with slices of material to be packaged, in particular foodstuff slices or other materials to be packaged, subsequently closed with an upper film and then separated. The disadvantage with the prior art is that the transfer of heat and/or the transfer of force between the film web and a heating device or a tool is inadequate and/or that the film web is damaged during the processing thereof in the packaging machine.

The object of the present invention was, therefore, to provide a packaging machine which offers improved beat transfer and/or improved force transfer between the film web and a heating device or a tool and/or in which the film web is not damaged or at least visibly less damaged during the processing thereof in the packaging machine.

The object is achieved by a packaging machine having:
a heating device, which heats a film web,
a molding station by moans of which packaging depressions are molded in the film, web and/or the upper film web, preferably by deep drawing,
a filling station in which the packaging depressions are filled with a material to be packaged,
a sealing station which seals an upper film web to the packaging depression, and
a longitudinal and/or transverse cutter, which separates the finished packages,

wherein the packaging machine has a porous agent, to which a negative pressure and/or positive pressure is applied and/or which transfers energy to the film web by means of thermal conduction.

The disclosure made in relation to this subject of the present invention applies to the same extent to the other subjects of the present invention and vice versa.

The present invention relates to a packaging machine, in particular a forming-filling-sealing packaging machine (FFS packaging machine). In said packaging machines, a film web/lover firm web is transported, preferably cyclically, along the packaging machine and firstly heated. Then, one or more packaging depression(s) is/are molded into the lower film web into the heated lower film web, wherein the packaging depression(s) are arranged in what is known as a format, which is produced during one cycle. This molding of the packaging depressions into the film web can be effected by a plunger or assisted by a plunger and/or be carried out by negative pressure in a female die and/or by pressing into a female die by positive pressure.

This packaging machine is then filled in a filling station with slices of material to be packaged, in particular foodstuff slices, or other material to be packaged that can be weighed and/or counted. After that an upper film is sealed onto the filled packaging depression. The upper film can also be deep-drawn. The finished packages are then separated by using a transverse and longitudinal cutter or with a contour cut.

The porous agent can be part of a beating device, in particular of a film heating device, of the molding station and/or of the sealing station.

Preferably, during one cycle, a format comprising X*Y packaging depressions is substantially simultaneously deep-drawn, filled and provided with an upper film. In the case in which a plurality of packaging depressions are molded simultaneously into the film web, preferably one female die and particularly preferably one plunger are provided per packaging depression.

According to the invention, the packaging machine has a porous agent, to which a negative pressure is applied and/or which transfers energy to the film web by means of thermal conduction.

The agent is preferably fabricated from a sintered, cast, foam, in particular reticulated foam, and/or a natural material with an adequate porosity.

The agent can also be produced by means of 3-D printing methods, for example from a metallic or non-metallic material, with which, for example, the properties of an at least, partially porous material, are simulated, with the advantage that both the usually stochastically arranged channels of the porosity are specifically produced, and arranged and also the dimensions of the channels are configured by the form, shape and/or sire of the outlet openings or other properties with regard to optimum flow characteristics, minimum flow losses, low or specific tendency to form Impressed patterns on the film, web.

A further preferred or inventive subject of the present invention is therefore a packaging machine in which the porous agent has a layered structure and/or is produced by a rapid-manufacturing method. A preferred method is a 3-D printing method, in which the material from which the porous component is made is applied layer by layer in the form of particles or as a free-flowing medium onto the layers lying underneath and is then connected to the latter. The connection can be made under the influence of temperature and/or pressure, by means of drying and/or by means of a chemical reaction. The particles which are respectively applied as a layer onto the layer lying underneath preferably have such large dimensions that, even following their connection to the layer lying underneath, a porous, e.g., air-permeable layer is produced.

Preferably, the porous agent has intercommunicating pores to which, for example, a negative or positive pressure can be applied, The diameter of the pores is, for example, 0.1-20, preferably 0.5-16, and particularly preferably 0.8-10 μm. The material of the agent is preferably so heat-resistant that a plastic film can be heated tip to its glass temperature by using said agent.

Preferably, a negative pressure is applied to the porous agent and the latter is provided in such a way that, one of the surfaces thereof is provided adjacent to a film web. As a result of the negative pressure, the film web is attracted to the agent by suction and is therefore in intimate contact with the surface of the agent. By means of this contact, thermal energy can be transferred very well from the agent to the film, in particular by thermal conduction. The same is true of forces. As a result of the negative pressure, the film rests closely on the agent and takes the form of the surface and/or the surface structure of the latter. As a result, the film can be molded, for example deep-drawn, and/or provided with a specific surface structure.

Preferably, at least the part of the agent that is in contact with the heating agent has a means which reduces the adhesion between the respective film web and the surface of the agent. As a result, the film slips better on the surface of the porous agent and creasing is at least reduced. In addition, undesired adhesion of the film to the surface of the agent is reduced or even prevented as a result. This means can be, for example, a non-stick coating, an electrical charge or a covering. Alternatively or additionally, the agent itself can at least partly be made of a material with a low fractional coefficient. Suitable as a non-stick coating is, for example, PTFE (e.g. Teflon). Also conceivable is coating the agent with a powder. In addition, plasma nano-technology coatings are worth considering as a non-stick coating. In addition, the application of ouch coatings by means of 3-D printing is conceivable, wherein the agent is preferably also produced by means of 3-D printing and thus the surface thereof is known with regard to the porosity situation, so that the surface regions between the pores are printed specifically in order not to close the pores themselves in an undesired manner. The surface of the agent itself and/or the coating thereof can subsequently be treated, for example by grinding or lapping. Furthermore, it is possible to cover the surface of the agent with an air-permeable layer which has non-stick properties, preferably with respect to the film. This layer can be connected in a form-fitting, force-fitting and/or integral manner to the agent. In this case, the film is laid on the layer as soon as the agent is subjected to a negative pressure and/or positive pressure and assumes the form and/or surface structure of said, agent.

Preferably, the porous agent is part of a heating device and a negative pressure is applied to the porous agent. This heating device can heat the lower film web and/or the upper film web, for example before the deformation of the latter. The agent is preferably provided in a heated structure which preferably has electric heating wires. The porous agent itself is preferably coated with a heating layer, which particularly preferably also has non-stick properties. For example, such a heating layer can be an electrically conductive coating. The heat is led from the structure through the agent to the surface of the latter which is in contact with the respective film web. The negative pressure connection is preferably also on the structure.

It is further preferred for the porous agent to be part, of a female die of the molding station, wherein negative pressure and/or positive pressure is preferably applied to the female die. By means of the negative pressure, the heated film web is sacked into the female die and/or forced into the latter by the positive pressure and in the process molded or the surface structure thereof is changed.

The porous agent can also be part of a plunger which moulds the film web and/or assists the molding of the film web. For the purpose of additionally assisting the molding of the film web, negative and/or positive pressure can be applied to the plunger.

According to a further inventive embodiment, the porous agent is part of a product support. In particular, after the packaging depressions have been loaded with the material to be packaged, said depressions have to be supported in order that the film web does not sag or does not sag too much. The porous agent can be part of this product support. Particularly preferably, air is blown out of the porous agent, so that an air cushion is produced between the film web and the product support, which reduces the friction between the film web and the product support.

The porous agent is preferably part of the sealing station, in particular part of the sealing frame or part of a molding station with which the upper film is molded or the surface structure thereof is changed.

It is further preferred, for the porous agent also to be part of a labeling device. Preferably, the agent is part of a dispenser box, with which the labels are fixed to the packages after the latter have been separated from the carrier strip. The labels are preferably attracted to the porous agent by suction, using negative pressure. After the respective label has been arranged on the package, the negative pressure is preferably dissipated in order to reduce the adhesive force between the porous agent and the label. Particularly preferably, compressed air is then even applied to the porous agent in order to reduce undesired adhesion, of labels or sub-regions of labels to the porous agent. The compressed air can also be used at least in a supporting manner in order to arrange the labels on the package.

It is likewise preferred for the packaging machine to have deflection rollers with which the film, is guided and/or is provided with a pre-tensioning force, wherein the deflection rollers consist of a porous agent, at least on their surface, to which an air stream is connected. As a result, the contact of the film with the deflection roller is prevented or at least minimized, as a result of which the introduction of forces, such as arise, for example, in the contact region between the deflection rollers of the film during driving and/or braking, is prevented or at least minimized. Such forces can be responsible for the undesired lateral run-off of films.

Preferably, in the event, of an in particular unintended or process-induced stoppage of the packaging machine, an air stream is connected to the porous agent, holding the film web at a distance from, the porous agent and/or cooling the same. This prevents the film web being heated up too much. As soon as the unintended or process-induced stoppage has been eliminated, the film web is attracted to the porous agent again by suction and heat and/or a force is transferred to the film web,

A farther subject of the present invention is a method for heating a film web by using a heating device which has a heated porous agent, in which a negative pressure, which attracts the film web onto the porous agent by suction, is applied to the porous agent.

The disclosure made in relation to this subject of the present invention applies to the same extent to the other subjects of the present invention and vice versa.

Preferably, the film web is transported cyclically along a packaging machine and stops during the heating of the film web.

Preferably, the negative pressure is applied only intermittently to the porous agent. In particular when the film web is transported onward, there is preferably no negative pressure applied to the porous agent, but possibly a positive pressure.

According to a further preferred embodiment, the negative pressure is not applied over the entire length and/or width of a format but sectionally. As a result, the film web is smoothed out and creasing is at least reduced. Particularly preferably, the sections have negative pressure applied thereto separately and in a time sequence, which also means that the smoothing of the film web and the reduction of creasing are assisted.

Preferably, in the event of a process stoppage, the porous agent has positive pressure applied thereto, which spaces the film web apart from the porous agent, in order to avoid overheating of the film web.

A further subject, is a method for molding a packaging depression, in which a porous agent (21) has a positive and/or a negative pressure applied thereto and this negative and/or positive pressure is transferred to a preferably heated film web and molds the latter.

The explanations given in relation to this subject of the present invention apply to the same extent to the other subjects of the present invention and vice versa.

A further subject is a method for sealing a cover film onto a packaging depression, in which a porous agent (21) is used to seal a cover film onto the packaging depression.

The explanations given in relation to this subject of the present invention apply to the same extent to the other subjects of the present invention and vice versa.

The porous agent preferably has an elevated temperature and/or is pressed against the packaging depression and/or the cover film.

A further subject is a method for transporting a packaging depression, which is supported by a product support during the transport, wherein the product support has a porous agent along which the packaging depression is transported. Preferably, an air stream flows out of the porous agent.

The explanations given in relation to this subject of the present invention apply to the same extent to the other subjects of the present invention and vice versa.

A further subject of the present invention is a method for changing the optical, properties of a film web, in which the film web is brought into contact with the surface of a heated porous agent, at least in some sections, and the surface structure of said agent is transferred to the surface of the film web, at least in some sections. is a result, a transparent film becomes at least partially cloudy or at least patterned.

The explanations given, in relation to this subject of the present invention apply to the same extent to the other subjects of the present invention and vice versa.

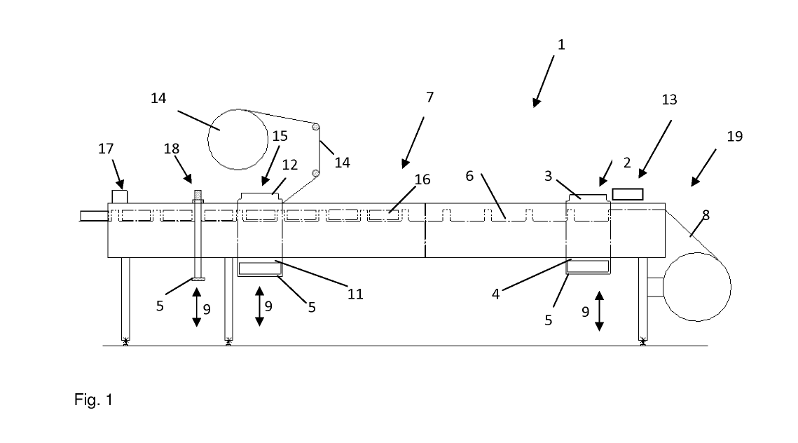

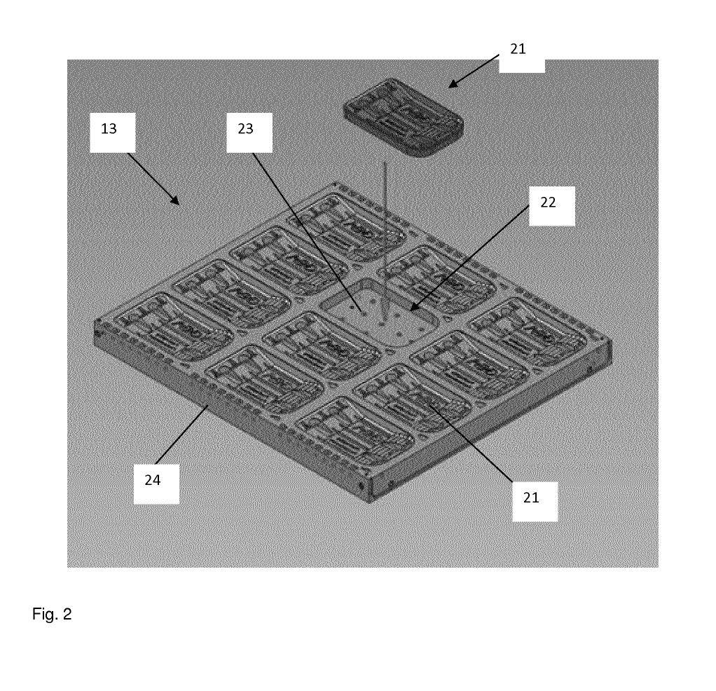

In the following text, the inventions will be explained by using FIGS. 1 and 2. These explanations are merely exemplary and do not restrict the general idea of the invention. The explanations apply to the same extent to all the subjects of the present invention.

FIG. 1 shows the packaging machine according to the invention.

FIG. 2 shows a heating device having a plurality of porous agents.

FIG. 1 shows the packaging machine 1 according to the invention, which has a deep-drawing station 2, a filling station 7 and a sealing station 19. A lower film web 8, here a plastic film web 8, is drawn off a supply roll and transported from right to left cyclically along the packaging machine according to the invention. During a cycle, the lower film web 8 is transported onward by one format length. For this purpose, the packaging machine has two transport means (not illustrated), in the present case respectively two endless chains which are arranged on the right and. left of the lower film web 8. Both at the start and at the end of the packaging machine, at least one gear wheel, around which the respective chain is deflected, is respectively provided for each chain. at least one of these gear wheels is driven. The gear wheels in the input area and/or in the output area can be connected to each other, preferably by a rigid shaft. Each transport means has a multiplicity of clamping means, which grip the lower film web 8 in a clamping manner in the input area 24 and transfer the movement of the transport means to the lower film web 8. In the output-area of the packaging machine, the clamping connection between the transport means and the lower film web 8 is released again. First of all, the lower film web 8 is heated, in particular heated to its glass temperature. This is preferably carried out while the film web is at a standstill. In the following deep-drawing station 2, which has an upper tool 3 and a lower tool 4 which has a shape (female die) of the packaging depression to be produced, the packaging depressions 6 are molded into the film web 8. The lower tool 4 is arranged on a lifting table 5 which, as symbolized by the double arrow, can be displaced vertically. Before each film feed, the lower tool 4 is lowered and then raised again. The molding of the lower web particularly preferably per packaging depression is preferably at least assisted by a plunger, which is respectively provided on the upper tool 3 and is lowered by a drive from a raised parking position into a molding position and raised again before the onward transport of the film web 8. In the further course of the packaging machine, the packaging depressions are then filled in the filling station 7 with the sliced material 16 to be packaged. In the following sealing station 15, which likewise comprises an upper tool 12 and a vertically displaceable lower tool 11, an upper film 14 is fixed integrally to the lower film web 8, preferably by means of sealing. For this purpose, the sealing station generally has a heated sealing frame. Also in the sealing station, the upper tool and/or the lower tool are lowered and raised, respectively, before and after each film transport. The upper film 14 can also be guided in transport means or transported by transport chains, these transport means then extending only from the sealing station and possibly downstream. Furthermore, the upper film can also be deep-drawn and be heated before the deep drawing. Otherwise, the explanations which have been made in relation to the transport means of the lower film apply. In the further course of the packaging machine, the finished packages are separated, which in the present case is carried out by using the transverse cutter 18 and the Longitudinal cutter 17. The transverse cutter 18 in the present case can likewise be raised and lowered by using a lifting device 9.

FIG. 2 shows a heating plate 13, with which the lower film web is heated before the deep drawing. The heating plate has a structure 24, for example an aluminum structure. Provided in the structure is at least one heating element, preferably a plurality thereof, with which the heating plate is heated. Furthermore, at least one channel, preferably a plurality thereof, with which a negative pressure and/or a positive pressure can be applied to the rear side of the inserts 21 in the recess 22, is/are provided in the structure. Furthermore, the structure has a multiplicity of recesses 22, twelve here, which are arranged in a format 3×4, i.e. one recess 22 and one insert 21, respectively, are provided for each package to be produced. Each recess 22 accommodates an insert 21, preferably reversibly. At least one spacer 23, with which a gap is produced between the structure 24 and the insert 21, is preferably provided in each recess 22. According to the invention, the inserts 21 are made of a porous material. For example, each insert 21 is made of a sintered metal. Preferably, the surface of the insert 21 that faces the film web is not flat but has a depression arid/or an elevation, so that the film web can simultaneously be pre-molded as it is heated. According to the invention, a negative pressure is now applied to the structure 24, propagates as far as the surface of each insert 21 and there leads to an air stream in the direction of the insert 21 and attracts the film web to each insert 21 by suction. As a result, very intimate contact is produced between the surface of the insert 21 and the film web 8, and the heated insert 21 transfers its heat to the film web 8, in particular by thermal conduction. At the same time, the structure of the insert 21 is preferably impressed into the film web 8.

### LIST OF DESIGNATIONS

1 Packaging machine

2 Molding station, deep-drawing station

3 Upper tool of the deep-drawing station

4 Lower tool of the deep-drawing station

5 Lifting table, carrier of a tool of the sealing, deep-drawing station and/or the cutting device

6 Packaging depression

7 stirs t filling station

8 Film web, lower film web

9 Lifting device

10 Drive

11 Lower tool of the sealing station

12 Upper tool of the sealing station

13 Heating device, heating means, heating plate, sealing frame

14 Upper film web, cover film

15 Sealing station

16 Material to foe packaged

17 Longitudinal cutter

18 Transverse cutter

19 Input area

20 Deep-drawing plunger

21 Insert

22 Recess

23 Spacer

24 Structure of the heating plate 13

1. A packaging machine having;
i. a heating device, which heats a film web,
ii. a molding station by means of which packaging depressions are molded in the film web and/or in an upper film web by deep drawing,
iii. a filling station in which the packaging depressions are filled with a material to be packaged,
iv. a sealing station which seals the upper film web to the packaging depressions, and
v. a longitudinal and/or transverse cutter, which separates finished packages,
characterized in that the heating device has a porous agent, to which a negative pressure and/or a positive pressure is applied and/or which transfers energy to the film web by means of thermal conduction.

2. The packaging machine as claimed in claim 1, characterized in that the porous agent is part of a heating device and the negative pressure is applied to the porous agent.

3. The packaging machine as claimed in claim 1, characterized in that the porous agent is part of a female die of the molding station, wherein the positive pressure is applied to the female die.

4. The packaging machine as claimed in claim 1, characterized in that the porous agent is part of a plunger.

5. The packaging machine as claimed in claim 1, characterized in that the porous agent is part of a product support.

6. The packaging machine as claimed in claim 1, characterized in that the porous agent is part of the sealing station.

7. The packaging machine as claimed in claim 6, characterized in that the porous agent is part of a sealing frame.

8. The packaging machine as claimed in claim 1, characterized in that the porous agent is part of a labeling device.

9. The packaging machine as claimed in claim 1, characterized in that the porous agent has a non-stick coating.

10. The packaging machine as claimed in claim 1, characterized in that the porous agent is sintered.

11. The packaging machine as claimed in claim 1, characterized in that during a stoppage thereof, the porous agent is connected to an air stream.

12. The packaging machine as claimed in claim 1, characterized in that the porous agent is built up layer by layer by a rapid-manufacturing method.

13. The packaging machine as claimed in claim 1, characterized in that the porous agent is coated with a heating layer,
wherein the heating layer is provided on a surface that is in contact with the film web.

14. A method comprising:
heating a film web by using a heating device which has a heated porous agent, characterized in that a negative pressure, which attracts the film web onto the porous agent by suction, is applied to the porous agent.

15. The method as claimed in claim 14, characterized in that the film web is transported cyclically along a packaging machine and stops during the heating of the film web.

16. The method as claimed in claim 15, characterized in that the film web of a format is attracted sequentially onto the heating device by suction.

17. The method as claimed in claim 16, characterized in that air is applied to the porous agent during a process stoppage.

18. A packaging machine comprising:
i. a heating device that heats a film web, the heating device comprising one or more porous inserts to which a negative pressure is applied;
ii. a molding station deep-drawing one or more packaging depressions in the film web;
iii. a filling station in which the one or more packaging depressions are filled with a material to be packaged;
iv. a sealing station which seals an tipper film web to the one or more packaging depressions; and
v. a longitudinal and/or transverse cutter that separates the one or more packing depressions after the one or more packaging depressions are filled with the material;
vi. at least one spacer provided between the heating device and the one or more porous inserts so that a gap is defined therebetween;
wherein the negative pressure attracts the lower web to the one or more porous inserts so that the lower web contacts the one or more porous inserts so that the heating device can transfer heat to the film web by thermal conduction, and
wherein a positive pressure is connected to the one or more porous inserts so that during a process stoppage, the positive pressure spaces the film web apart from the one or more porous inserts to avoid overheating of the film web.

19. The packing machine as claimed in claim 18, wherein the molding station comprises an upper tool and a lower female tool that, cooperate to deep-draw the one or more packaging depressions in the film web, and
wherein the negative pressure is applied to the female die.

20. The packing machine as claimed in claim 18, wherein the one or more porous inserts include pores having a diameter on the order of approximately 0.8 to 10 μm, and
wherein the negative pressure attracts the lower web to the one or more porous inserts so that the lower web takes form of a surface structure of the one or more porous inserts.
